(19) United States
(12) Patent Application Publication
(10) Pub. No.: US 2008/0016069 A1
(43) Pub. Date: Jan. 17, 2008

(54) Examiner information system

(75) Inventor: Christopher L. Holt, Edina, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Ficus Enterprises, LLC, Edina, MN (US)

(21) Appl. No.: 11/891,101

(22) Filed: Aug. 9, 2007

Related U.S. Application Data
(63) Continuation of application No. 11/801,799, filed on May 11, 2007.
Application No. 11/801,799 is a continuation of application No. 11/487,526, filed on Jul. 14, 2006.

(51) Int. Cl. G06F 17/30

(52) U.S. Cl. 707/6

(57) ABSTRACT

A patent Examiner information accessing system access patent Examiner information from a Patent and Trademark Office, or other, database. A search system is provided so that a user can search information aggregated by the Examiner information accessing system.

The present application is a continuation of, and claims priority of, U.S. patent application Ser. No. 11/801,799, filed May 11, 2007 entitled EXAMINER INFORMATION SYSTEM, and the present application is also a continuation of, and claims priority of, U.S. patent application Ser. No. 11/487,526, filed Jul. 14, 2006, entitled SYSTEM AND METHODS FOR PROVIDING INFORMATION ABOUT PATENT EXAMINERS, the content of both applications being hereby incorporated by reference in its entirety.

### BACKGROUND

It is natural for a person who is tasked with influencing a decision-maker to be curious about the decision-maker's background. Further, if the person is pre-equipped with insight into the decision-maker's previous decisions, this could give an advantage in terms of the person's ability to effectively advocate for a particular outcome. It comes as no surprise that entire industries have sprung up around providing information about decision-makers.

An attorney who is to appear before a judge has a variety of resources available from which information about the judge can be learned. For example, it is generally not difficult for the attorney to obtain previous written opinions authored by the judge. In fact, it is relatively easy to obtain previous written opinions specifically dealing with topics that are on-point or similar to the attorney's current needs or interests. There are well-known commercial and public resources for acquiring this type of information.

Further, there are a variety of resources available that provide information related to a given judge's personal background. In some jurisdictions, there are court web sites that provide background information about judges. Periodicals, such as those published by bar associations, often publish interviews and/or judicial profiles. In addition, certain specialized commercial and public informational services provide the public with background information about lawyers and/or judges.

Another kind of decision maker is a patent Examiner. A patent Examiner, typically an employee of a patent office, is tasked with reviewing patent applications and making decisions related to the patent process. An Examiner is typically tasked with, among other things, deciding how many inventions are claimed in a given application, deciding whether the application satisfies certain formal requirements, deciding whether a patent should be granted to cover any invention claimed in the application, and deciding the scope of any patent to be granted.

In many countries, including the United States, as a patent Examiner makes decisions during the patenting process, an inventor and/or an advocate (e.g., a representative of an inventor and/or a representative of an assignee of an inventor's rights) is given opportunities to interact with the Examiner. At least some of these interactions represent opportunities to urge the Examiner toward a particular outcome or decision.

Under the circumstances, it is natural for a person who is tasked with interacting with a patent Examiner to be curious about the Examiner's background and/or previous decisions. Unfortunately, at least in the United States, there is currently no convenient way to efficiently gather information on an Examiner-specific basis. In fact, it is not uncommon for an inventor or an advocate to know very little about the Examiner with whom they are interacting during the process of moving a patent application through the patenting process.

### SUMMARY

A patent Examiner information accessing system is disclosed for accessing patent Examiner information from a Patent and Trademark Office, or other, database. A search system is provided so that a user can search information aggregated by the Examiner information accessing system.

### BRIEF DESCRIPTION OF THE DRAWINGS

FIGS. 1A and 1B (FIG. 1) are a block diagram of one information accessing system in accordance with one embodiment.

FIGS. 2-14 are user interfaces that illustrate embodiments of the operation of the system shown in FIG. 1.

FIG. 15 is a flow diagram illustrating one embodiment of providing report or consultation services.

FIG. 16 is a block diagram of a data accessing system in greater detail.

Appendices A-E show embodiments of a Patent and Trademark Office interface that makes patented data available to the aggregation system.

Appendix F illustrates various embodiments that can be used on a search interface.

### DETAILED DESCRIPTION

System 100 includes an Examiner information accessing system 102 that accesses Examiner data through Examiner data system 104. Examiner information accessing system 102 aggregates data and can index it in a variety of different ways, illustratively one way is by Examiner, and stores it in aggregated Examiner data store 106. It will be noted that data store 106 can be integrated within Examiner information accessing system 102 or separate therefrom.

In any case, search user interface system 108 is also shown coupled to system 102. Search user interface system 108 generates search user interfaces 110 for use by a user 112 through a network 114. A variety of different embodiments of user interface 110 are described below. They assist in illustrating the operation of system 100.

In one embodiment, user 112 wishes to obtain information from aggregated Examiner data store 106. For instance, assume that user 112 is a patent attorney that is prosecuting a patent application before a given Examiner. The patent attorney (user 112) may wish to view Office Actions issued by that Examiner in similar cases, using similar prior art, or using similar rejections, or all of the above. User 112 will thus illustratively provide a query 116 through an interface (search UI) 110 that is generated by search user interface system 108.

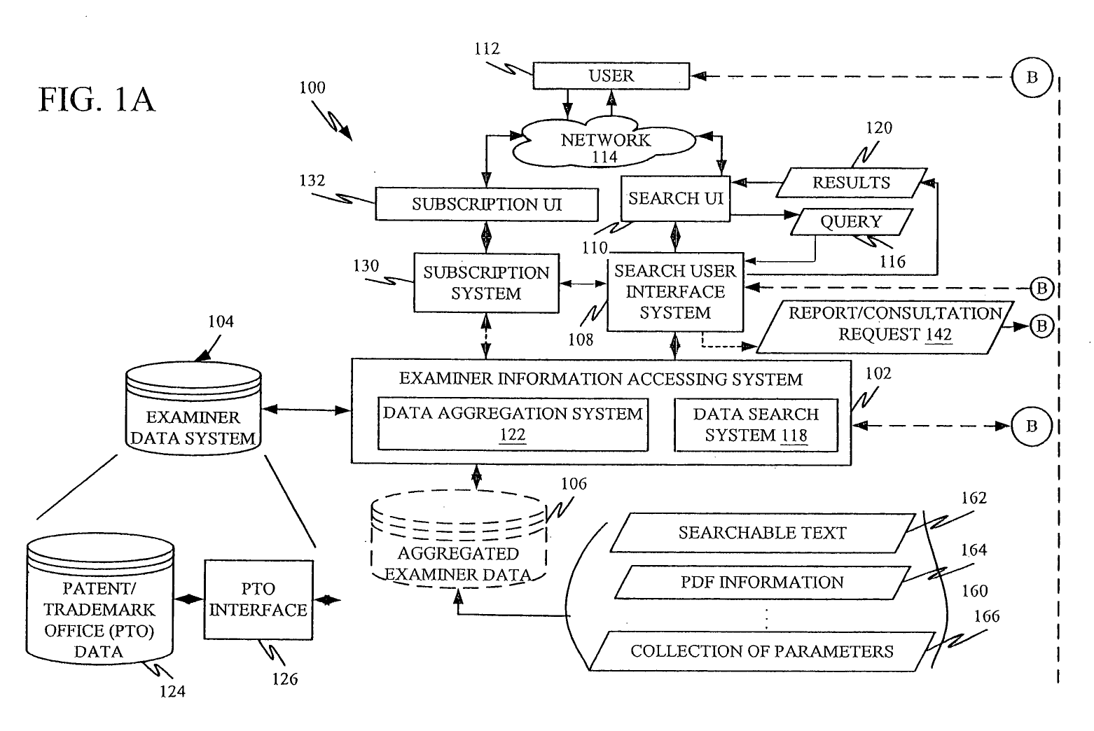

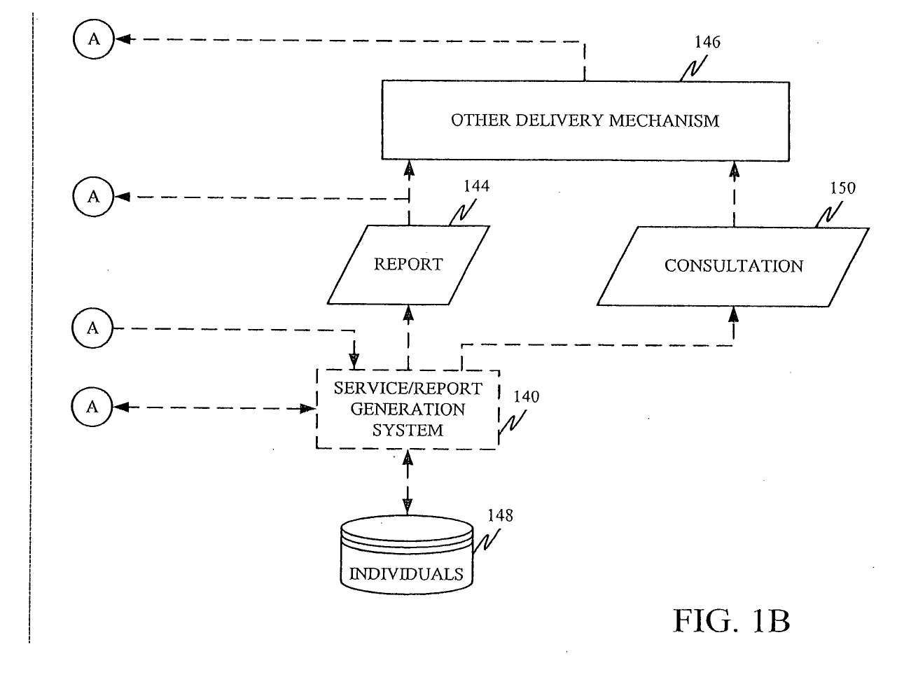

FIG. 1 shows that Examiner information accessing system 102 includes a data search system 118 and data aggregation system 122. The query 116 is provided to data search system 118 which, in turn, executes the query against aggregated Examiner data 106 (though it should be noted that it is also within the scope of the scope of the present invention for the queries to executed against another collection of data such as but not limited to data associated with an examiner data system 104, which will be described in greater detail below). The data search system 118 may illustratively be a conventional search engine or another type of searching system that searches through aggregated Examiner data 106. In any case, data search system 118 generates results 120 that are provided, through search user interface system 108, and through the search UI 110 generated by system 108, to a user over network 114. The query 116 and results 120 can contain any of a wide variety of different information, depending on what the user 112 desires, and depending on the type of data aggregated in aggregated Examiner data store 106.

In order to aggregate that data, Examiner information accessing system 102 illustratively includes data aggregation system 122. Data aggregation system 122 accesses, and extracts some of, the data in Examiner data system 104. In one embodiment, system 104 includes Patent/Trademark Office (PTO) data stored in data store 124 which is accessed through PTO interface 126 that is exposed by the United States Patent and Trademark Office. Of course, the source of the data aggregated by data aggregation system 122 and stored in data store 106 can be a different source, other than the United States Patent and Trademark Office database system. For instance, it may be a separate entity that has purchased or otherwise obtained data from the United States Patent and Trademark Office, or it might be that aggregated Examiner data 106 is purchased or otherwise obtained directly from the United States Patent Office, without aggregating the data using data aggregation system 122.

In any case, however, aggregated Examiner data 106 illustratively includes some embodiments of which are indicated by numeral 160. For example, the data can include searchable text 162. The searchable text may illustratively be the text of the Office Actions and/or responses to Office Actions stored in the file histories for various patent applications, indexed by a collection of different search parameters 166. For instance, the collection of parameters which define how the information can be searched may include keywords, the Examiner name, the attorney name who is handling the case, types of rejections which the Examiner has used (such as rejections under 35 U.S.C. §101, 102, 103, 112, etc.). The type of parameters that can be used in searching aggregated Examiner data 106 will be described in more detail below, by way of example. Data 106 may also illustratively include PDF information 164, such as PDF images of various items in the file histories of various patent applications, the data for which is stored in aggregated Examiner data 106.

It will also be noted that where free text searching is provided (described in more detail below), the data in store 106 need not be indexed by the search parameters, but instead a text search is simply performed during runtime. However, indexing may be desired as well (i.e., in combination with free text searching).

To give further examples of the types of data that can be aggregated into store 106, Appendices A-E illustrate various types of PTO data 124 that are currently available, and that could be obtained using data aggregation system 122. The types of data also illustrate the various types of parameters 166 that can be used for searching.

Appendix A shows that, for a given serial number (here the serial number is a fictitious Ser. No. 10/012,345) a title is given, here the title is “Stalling Instructions in a Pipeline Microprocessor”. In Appendix A, bibliographic data for that serial number is listed. The bibliographic data includes the application number, the filing date, the application type (such as utility, plant, design, etc.), the Examiner name, the group art unit, the confirmation number, the attorney docket number, the class/subclass for this serial number, the first named inventor, the customer number, the status of the application, the date on which the status was last updated, the location within the Patent Office of the file, the date on which the location was last updated, the earliest publication number of the application, the earliest publication date, the patent number and issue date of the patent, if any. All of this information is obtainable and all, or any, of it may be aggregated into data store 106, as desired. Any of this information can be implemented as a searchable parameter and made available to user 112 as a basis for formulating a search.

Exhibit B illustrates more information that can be aggregated in aggregated Examiner data store 106. Again, for a given serial number, a transaction history is available in PTO data 124. The transaction history (one of which is shown in Exhibit B) includes a date column and a transaction description column. The date column indicates the date of the transaction identified by the transaction description. Of course, any of the transactions may be interesting to a given user 112. Of note, however, are the rejections issued by the Examiner, and whether they were final or non-final rejections, whether the case is abandoned, etc. A wide variety of different transactions can be described in the transaction history shown in Appendix B and those listed are listed for the sake of example only. Any of this information can be implemented as a searchable parameter and made available to user 112 as a basis for formulating a search.

Appendix C identifies continuity data associated with the listed serial number. The continuity data indicates whether any child continuity data has been listed for this application, and the status of the parent case, along with the patent number of the parent case, if any. Any of this information can be implemented as a searchable parameter and made available to user 112 as a basis for formulating a search.

Appendix D shows publication dates and details associated with those dates for the listed serial number. Any of this information can be implemented as a searchable parameter and made available to user 112 as a basis for formulating a search.

Appendix E shows the attorney or agent and correspondence information associated with the serial number. Of course, the information listed in Appendix E is fictitious and is used for the sake of example only. Any of this information can be implemented as a searchable parameter and made available to user 112 as a basis for formulating a search.

Other information available from the PTO data store 124 may illustratively include the images of the items in the file wrapper for the given serial number. For instance, there may be PDF or other images available for all items of correspondence between the Patent Office and the applicant, or the attorney/agent of record. Some of those items may include, for example, the application itself, information disclosure statements, office actions, restriction requirements, all correspondence from the Patent Office, responses to those items of correspondence from the applicant, attorney or agent, notices of allowance or abandonment, reexamination request, request for reissue, and all other items of information exchanged between the patent and agent, or third parties, including the issued patent itself.

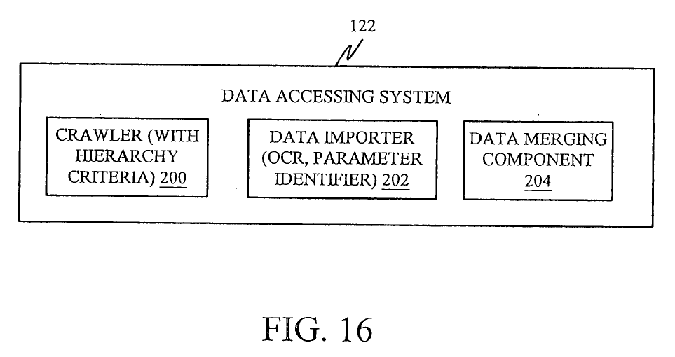

In accessing these types of images, data aggregation system 122 illustratively converts at least some of them to searchable text 162. One embodiment for doing this involves an embodiment of data accessing system 122 shown in FIG. 16. FIG. 16 is a more detailed block diagram of data accessing system 122 and illustratively includes crawler 200, data importer (which may be an optical character recognition OCR parameter identifier) 202, and data merging component 204.

Crawler 200 illustratively includes a spider that continuously or periodically, crawls through PTO data 124 to aggregate data in data store 106. Crawler 200 can illustratively be directed by a hierarchy of aggregation criteria which indicates what types of information crawler 200 is to download in a preferential order. For instance, in one embodiment, crawler 200 can be directed to first download all of the documents associated with a given list of serial numbers. Alternatively, or in hierarchical order, crawler 200 may be directed to download information for a list of assignees, inventors, dates, group art units, based on the named inventor, classes or subclasses where applications are classified, etc. The hierarchical criteria used for aggregating the data can be any criteria desired and the hierarchical criteria can be arranged in any hierarchy desired. Those listed are simply listed by way of example.

Accordingly, if it is desired that crawler 200 aggregate the most recent data first, then the first aggregation criteria listed might be the date or date range of interest. In that case, crawler 200 will focus on downloading information for serial numbers of applications that have been filed most recently or applications that have been pending the longest. If the next criteria in the hierarchy is a group art unit, then crawler 200 will focus more preferentially on aggregating data corresponding to the most recent information in the designated group art unit. Of course, the aggregation criteria need not be hierarchical but could simply be flat in which case assuming that crawler 200 is to download the most recent information first, it downloads all information within a given date range and then focuses on the next criteria such as the information in a given art unit. Any desired combination of aggregation criteria can be used, including a single criterion.

In one embodiment, crawler 200 is configured to check the file histories of different serial numbers so as to determine if an office action not already included in data 106 has issued. If there is such a document, crawler 200 illustratively adds it to data 106. In one embodiment, crawler 200 is configured to implement preferences in terms of which serial numbers get checked first for updates. In one example of such a preference, cases where an office action has issued recently but a patent has not issued are placed higher in cue for update checking than cases where a substantive office action has not yet been issued. In another example, cases that have been pending longer are given priority. In another example, certain art units, are given a preference. In another example, cases where patents have issued or prosecution has been abandoned are eliminated from the update cue. Any of these examples of preferences can be imposed individually or in combination with one another. Of course, the scope of the present invention is not limited to these examples.

Crawler 200 may also be equipped to avoid accessing PTO data 124 during busy times (e.g., during PTO business hours). Further, crawler 200 may be configured to only access information at a rate that does not appreciably slow down the response time of system 104 (e.g., based on server response time or some other factor).

Data importer 202 illustratively receives the information aggregated by crawler 200 and generates corresponding searchable text 164, and also identifies and collects parameters 166 that can be used as the basis of a search. For instance, in one embodiment, a large amount of data in PTO data 124 is only available for aggregation in PDF format, or in an image format (e.g., TIFF, JPEG, etc.), or in some other format where text is not readily available. In one scenario, office action and response documents are electronically scanned into PTO data stores 124 and reside there as image files until requested, at which time they are delivered as image files or in another format such as PDF. Thus, these documents are not made available in a conveniently text searchable format. In that case, in one embodiment, data importer 202 performs optical character recognition on the documents to recognize the text in the documents and generate a searchable text version.

Data importer 202 illustratively also includes a parameter identifier component that identifies and collects various search parameters that may be used by user 112 in searching the aggregated data. Of course, the parameters can be used to index the data, or simply stored in a table (or other data structure) associated with each stored document. Also, a parameter can be identified by application of a comparison or classification model (e.g., a text comparison model applied to classify a document based on its textual content, one or more parameters being assigned accordingly) or in any other desired way at other points in the processing of the accessed documents. For instance, in one embodiment, the parameter identifier in data importer 202 illustratively looks for terms such as, but not limited to, the Examiner's name, “§101”, “§102”, “§103”, “§112”, “restriction requirement”, “double patenting”, recitations of statutory texts or rules, etc. The parameters may also be more specific such as “35 U.S.C. §102(b)”, “35 U.S.C. §102(e)”, or they may be less specific, such as “102”. The parameter identifier in data importer 202 will also, illustratively, identify any other parameters which will be searchable by a user, such as keywords, group art unit number, assignee name, etc. Of course, the list of parameters is virtually endless and any of those made available in PTO data 124 can be used in accordance with the present system. Also, importer 202 may generate a text searchable version of the aggregated data and retain the original data (such as the PDF version) as well.

Alternatively, some or all of the parameters need not be identified by importer 202. In one embodiment, importer 202 simply converts the aggregated data into text searchable form, and may retain the original version of the data, as desired.

In one embodiment, data accessing system 122 also includes a data merging component 204. It may happen, for instance, that the individual pages of documents in PTO data 124 are made available as separate PDF (or other) images. For example, the individual pages of an Office Action may illustratively be stored as separate image files and delivered as separated PDF images. In circumstances such as these, data merging component 204 illustratively identifies the various pages that correspond to a single document (such as all pages belonging to an individual Office Action) and merges them into a single text readable document, or a single PDF document, or both, and stores that document in aggregated Examiner data store 106.

Referring again to FIG. 1, it may be desirable to have user 112 subscribe to use system 102. In that case, subscription system 130 is provided and generates subscription user interface (subscription UI) 132 which can be used by user 112 to subscribe to use system 102. In one illustrative embodiment, subscription system 130 generates UI 132 so that it collects identification information, authentification information, and billing information from user 112 such that user 112 can either pay for, or be billed for, its use of system 102. Search system 108 illustratively requires a user 112 to log on, or otherwise validate its identity. That information can then be used by subscription system 130 to determine whether user 112 has a valid subscription. If so, subscription system 130 can authorize system 102 and system 108 to continue, and allow user 112 to execute searches, or to otherwise use system 102. If not, system 130 can offer user 112 the opportunity to subscribe, or can simply terminate the session and not respond to the request of user 112, or to respond with an explanation that the user has not subscribed, etc.

FIG. 1 also illustrates another illustrative embodiment in which optional service/report generation system 140 can be used to generate a report requested by user 112, or to offer consultation services requested by user 112. For instance, it may be that user 112 simply desires a statistical report that can be generated from the aggregated Examiner data 106. One exemplary report may be an indication of how often an Examiner is reversed on appeal, how often the Examiner has issued any given rejection, (such as rejections under any subdivisions of 35 U.S.C. §101, 102, 103, 112, etc.), how often a given Examiner (or set of Examiners within a given art unit) are issuing restriction requirements, or any of a wide variety of different types of statistical or other reports. Similarly, user 112 may desire a more detailed report, such as a summary of various responses that have been used to overcome office actions that include rejections based on a certain statutory section, or based on certain prior art references, issued by a given Examiner.

If user 112 desires such a report, user 112 illustratively submits a report/consultation request 142 through an appropriate user interface generated by search user interface system 108, to service/report generation system 140. System 140 illustratively includes the components required to obtain the necessary information (such as to generate necessary queries and aggregate necessary results) with respect to Examiner information accessing system 102. Where the user desires a summary of some type, system 140 or system 102 illustratively includes a summarizing component, such as a natural language processing system that automatically summarizes text. Once the information is obtained, service/report generation system 140 illustratively generates the desired report 144 and provides it back to the user 112 through system 108, or through other delivery mechanism 146. In some, various embodiments, other delivery mechanism 146 may include electronic mail (email), automated telephone messaging, or telephone call, tele-facsimile (i.e., fax), US mail or other delivery service, etc.

In another embodiment, user 112 may wish to have consultation services, in addition to or instead of, report 144. Service/report generation system 140 illustratively maintains a data store of individuals 148 that are particularly knowledgeable about certain Examiners, about certain group art units, about certain subject matter, etc. This data store of individuals 148 can be generated by system 140 in a variety of different ways. For instance, system 140 might simply generate data store of individuals 148 statistically by identifying particular attorneys or agents that consistently have cases before given Examiners, in a given art unit, with a given subject matter, etc. System 140 may also recruit individuals or allow individuals to register as “experts” or simply “consultants” in certain areas or with respect to certain parameters (such as, again, Examiners, group art units, types of rejections, etc.).

In such a system, report/consultation request 142 is received, through an appropriate user interface generated by system 108, from the user. The report/consultation request 142 identifies the parameters which are sought for consultation, and system 140 illustratively identifies individuals from data store of individuals 148 that may be suited to provide consultation services to user 112, given the consultation parameters indicated in report/consultation request 142 (alternatively, request 142 may direct a request to a given consultant as well). System 140 may then illustratively automatically contact a subset of individuals 148 that may be useful in providing the requested consultation services. That contact can be made manually by an administrator or other individual working in system 140, automatically through an automated telephone call, electronic mail message, paging message, by a tele-facsimile, etc. In any case, once an individual has agreed to provide consultation services, that individual provides consultation 150 to user 112, either as specified by the user, or as desired by the consultant, or in any other desired way. For instance, it may be that the individual identified to provide the consultation 150 simply calls the user 112 at a telephone number indicated in the report/consultation request 142. Alternatively, the individual may send an email to the user 112, fax the user 112, exchange messages through a chat room or bulletin board, provide information through a proprietary, and confidential web site, etc. A wide variety of different ways of providing consultation 150 can be used.

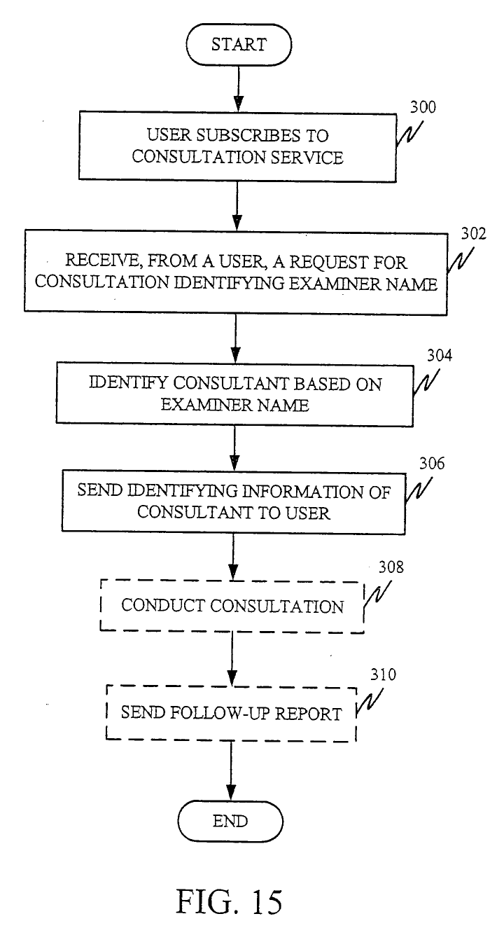

FIG. 15 is a flow diagram better illustrating one embodiment of providing consultation services. In FIG. 15, the user first subscribes to receive consultation services through subscription system 130. This is indicated by block 300. Next, system 140 receives, from user 112, a request for consultation identifying the information for which consultation is sought. In the embodiment set out in FIG. 15, the user 112 desires consultation regarding an individual Examiner, such as how to overcome rejections by the Examiner, how to conduct interviews with the Examiner, etc. Receiving the request is indicated by block 302 in FIG. 15. Next, system 140 identifies a consultant based upon the parameters for which consultation services are sought (in one embodiment, the parameters include the Examiner name). This is indicated by block 304 in FIG. 15. In the embodiment shown in FIG. 15, system 140 then sends to user 112 identifying information, identifying the consultant which is to be used in providing the consultation 150. This is indicated by block 306. The user may then contact the consultant, the consultant may contact the user, or both, and the consultation is conducted. This is indicated by block 308 in FIG. 15. The consultant may also desire to send a follow up report or user 112 may request a follow up report, summarizing the consultation. This is indicated by block 310 in FIG. 15. Of course, a wide variety of other methods can be employed to provide consultation services.

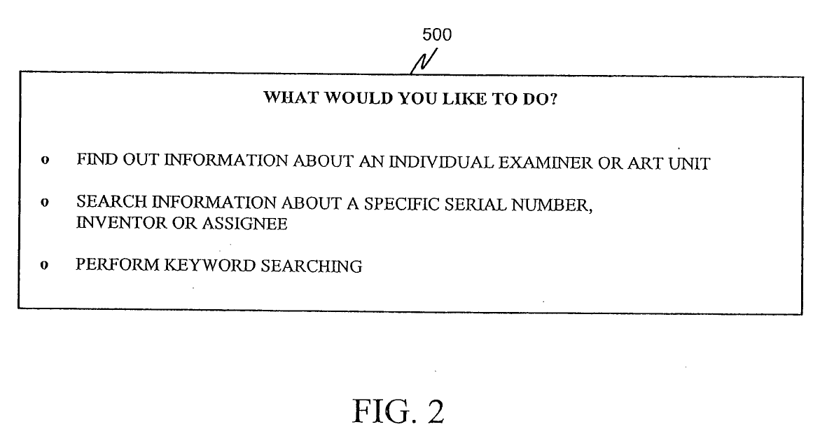

FIGS. 2-14 show a variety of different user interfaces which can be generated by system 108. These user interfaces are exemplary only and are used to illustrate one embodiment of the operation of system 100.

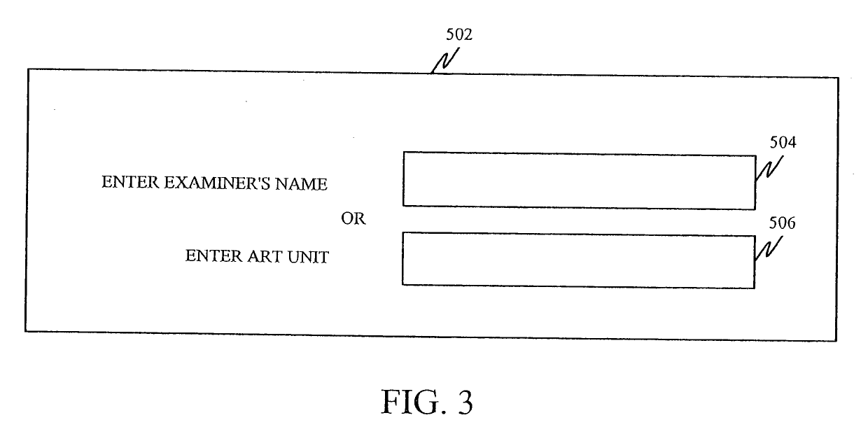

Assume a user 112 first logs onto or otherwise desires to access system 102. User interface system 108 may illustratively provide a first user interface, such as user interface 500 shown in FIG. 2. User interface 500 asks the user what the user would like to do and then presents a number of different radio buttons that can be selected by the user. For instance, in the embodiment shown in FIG. 2, the radio buttons ask the user if the user desires to: “find out information about an individual Examiner or art unit”, “search information about a specific serial number, inventor, or assignee”, and “perform keyword searching”. Assume that the user selects the first button and desires to find out information about an individual Examiner or art unit. In that case, system 108 presents the user with a more detailed selection user interface, such as that set out as 502 in FIG. 3. User interface 502 allows the user 112 to enter an Examiner's name in box 504 or an art unit number in box 506.

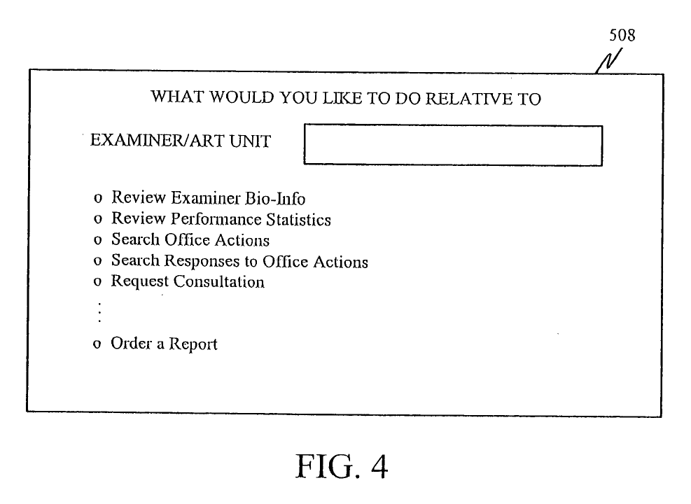

Assuming that the user enters an Examiner's name, user interface system 102 presents another user interface which asks the user 112 a more detailed question about what the user would like to do. One embodiment of this is shown at 508 in FIG. 4. User interface 508 in FIG. 4 asks the user what the user would like to do relative to the Examiner or art unit identified at user interface 502 in FIG. 3. Assume, for instance, in FIG. 3, the user has entered a particular Examiner's name in box 504. The user interface 508 in FIG. 4 then allows the user to review the Examiner's biographical information, review performance statistics for the Examiner, search office actions for that Examiner, search responses to office actions for that Examiner, request a consultation for that Examiner, order a report for that Examiner, etc. A wide variety of other things could be requested as well, and those listed in FIG. 4 are exemplary only. It will also be noted that the same, or similar options can be provided if the user enters an art unit in box 506 of user interface 502 shown in FIG. 3 (e.g., similar options but scoped to an art unit rather than to a particular examiner). It should also be noted that to the extent that the present description refers to scoping based on art unit, the scope of the present invention is not so limited. It is within the scope of the invention to facilitate research of groups of examiners based not just on art unit but on any other basis for grouping examiners.

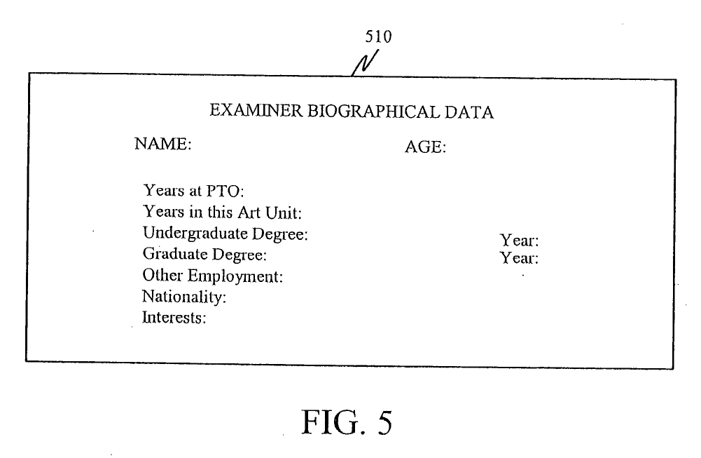

Assume that the user has requested to review the Examiner biographical information in FIG. 4. Data search system 118 then executes a predefined query to obtain the biographical information for the Examiner entered in the user interface in FIG. 3. User interface system 108 then presents a user interface, such as user interface 510 shown in FIG. 5, to user 112. User interface 510 simply lists a variety of Examiner biographical data for the given Examiner. The Examiner biographical information may be obtained directly from the Examiner, from the Patent Office data 124, by recruiting Examiners to enter their information, or by any other desired means. The biographical data is illustratively stored within database 106 and made available for retrieval by search system 118.

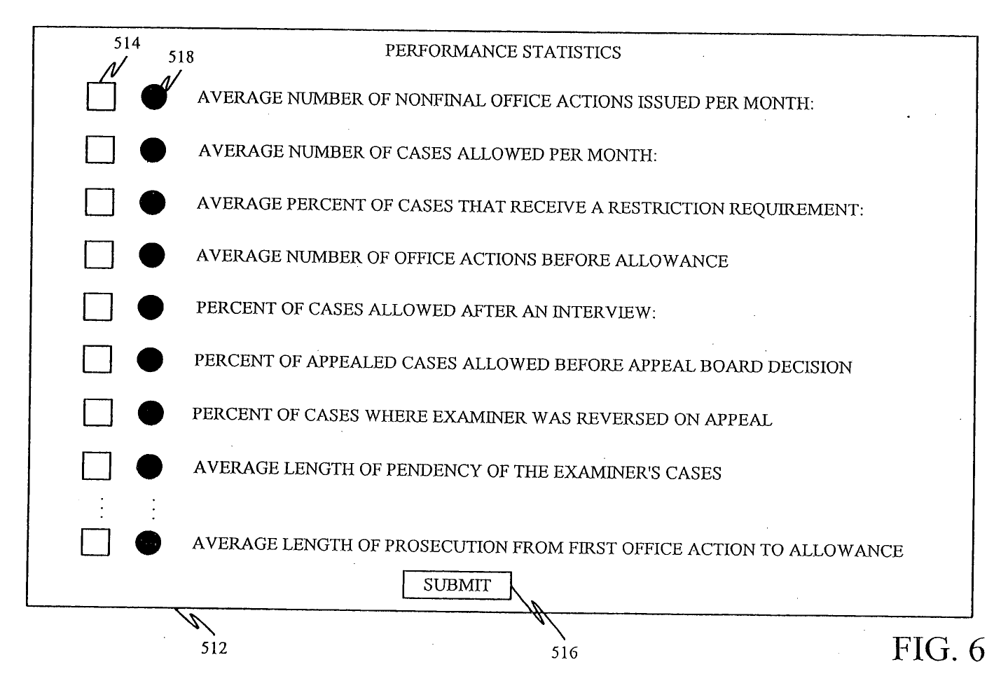

Assume that, in FIG. 4, the user has selected to review performance statistics for the identified Examiner. In that case, search user interface system 108 then presents another user interface to the user, specifically requesting that the user identify, or select, the various statistics which the user would like to review. One embodiment of such an interface is indicated by 512 in FIG. 6. In the embodiment shown in user interface 512, the user can either select a plurality of different types of statistics by hovering a cursor over check boxes 514 and selecting them (to place a check in them) and then, once all desired statistics are checked, actuate submit button 516.

Data search system 118 illustratively has the statistics for each of the Examiners precomputed and stored either in data store 106 or a separate data store of precomputed statistics. In that case, data search system 118 simply retrieves the selected statistics desired by the user and presents them, through an appropriate user interface generated by system 108, as results 120 to user 112. Alternatively, of course, data search system 118 need not have all, or any, of the statistics precomputed. System 118 will illustratively execute the necessary pre-formed queries against aggregated Examiner data 106 to generate the statistics desired by the user, and then present them to the user in a similar way. Alternatively, of course, data search system 118 may provide the performance statistics to report generation system 140 which generates a report 144 illustrating the statistics and provides that back to user 112 either through search user interface system 108 or through another delivery mechanism 146.

In another embodiment, in which the user actuates one of radio buttons 518, this causes data search system 118 to automatically generate (or retrieve) the statistics corresponding to that radio button and return them to the user either as a report, or through user interface system 108, or in any other desired way. Of course, the particular performance statistics listed in user interface 512 are exemplary only, and additional, or different, performance statistics can be provided as well. Those listed simply include the average number of non-final office actions issued by this Examiner per given unit of time (such as per month), the average number of cases allowed by this Examiner (e.g., per month), the average percentage of cases that receive a restriction requirement from this Examiner, the average number of office actions before allowance for this Examiner, the percent of this Examiner's cases allowed after an interview, the percent of this Examiner's cases that are appealed, the percent of this Examiner's appealed cases that are allowed before an Appeal Board decision, the percent of cases where the Examiner was reversed on appeal, the average length of pendency of this Examiner's cases, and the average length of prosecution from the first office action to allowance, for this Examiner, etc. Again, the statistics are exemplary only and different or additional statistics can be generated as well.

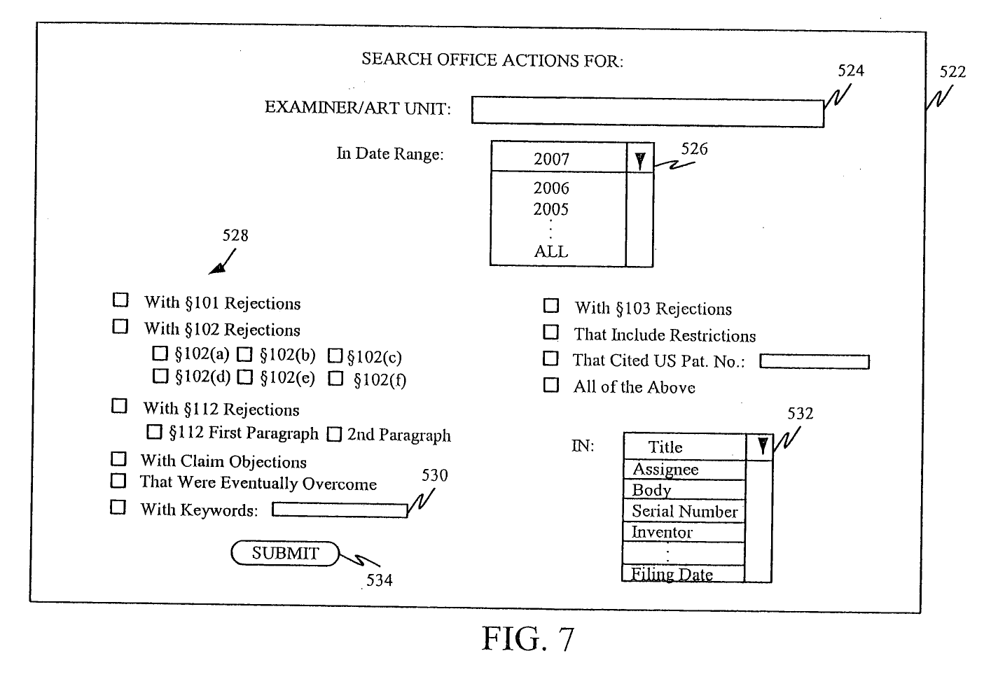

Assume that, in FIG. 4, the user has selected to search office actions for a given Examiner. System 108 then illustratively generates a user interface that allows the user 112 to more specifically identify the type of search which is to be conducted through the office actions. One such user interface is indicated by user interface 522 in FIG. 7. User interface 522 is an interface which allows a user to search office actions for the Examiner or art unit entered in user interface 502 in FIG. 3, and which will appear in box 524 in user interface 522. Again, the parameters which can be selected for searching the office actions shown in user interface 522 are exemplary only, and different or additional parameters can be used as well, and a different mechanism by which the parameters can be selected can be used also.

Those shown in the embodiment in FIG. 7 include a date range selection drop down menu 526 which allows a user to select a date range of office actions for this Examiner that are to be searched. Then, a plurality of different check boxes 528 are provided which allow the user to quickly and easily select the various parameters that the user desires to search for in the office actions issued by this Examiner. The parameters listed in FIG. 7 include, for instance, the different types of rejections made under the different statutory sections (such as §101, 102, 103, 112, etc.), and an even more detailed breakdown (such as which particular subparagraph under §102 of the rejection has been made, etc.), the office actions which include restriction requirements, the office actions that cited a particular patent number or other item of prior art, the office actions that contain claim objections, the office actions that were eventually overcome, or all of the above criteria.

In addition, user interface 522 allows the user to search for key words by simply checking the check box corresponding to the keyword field 530, and then entering desired keywords within field 530. The keywords can also be specified by indicating that they are located in a given portion of an office action by selecting a desired field from dropdown menu 532.

Once the particular search has been configured by selecting the various search parameters shown in user interface 522, the user can have the search conducted by actuating submit button 534. This causes data search system 118 to perform a search of the office actions for the identified Examiner. Of course, as with the performance statistics, data search system 118 can have some, none, or all of the information precomputed by performing searches offline, and storing the results of those searches for each individual Examiner (or for each other selected search parameter or criterion) in data store 106. Alternatively, of course, or where the data has not been precomputed, actuating submit button 534 causes data search system 118 to generate a query (or select one or more pre-formed queries) corresponding to the parameters selected in user interface 522, and launch that query against aggregated Examiner data 106 to obtain search results. Data search system 118 provides the search results to search user interface system 108 which provides them as results 120 through an appropriate search user interface 110 to user 112. Of course, as with the performance statistics, data search system 118 may provide the information to service/report generation system 140 which generates a report 144 and provides that to user 112.

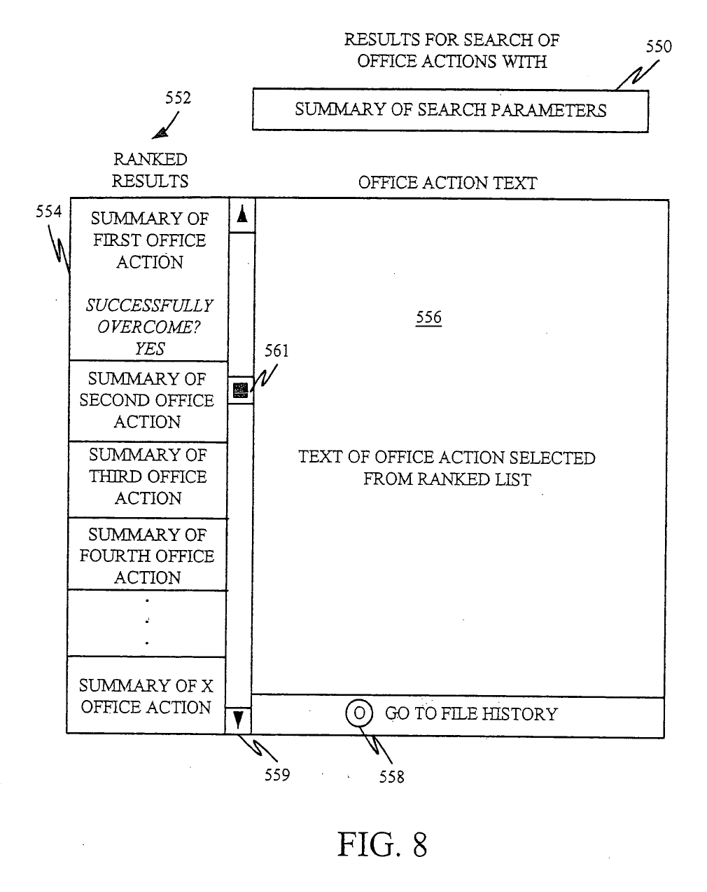

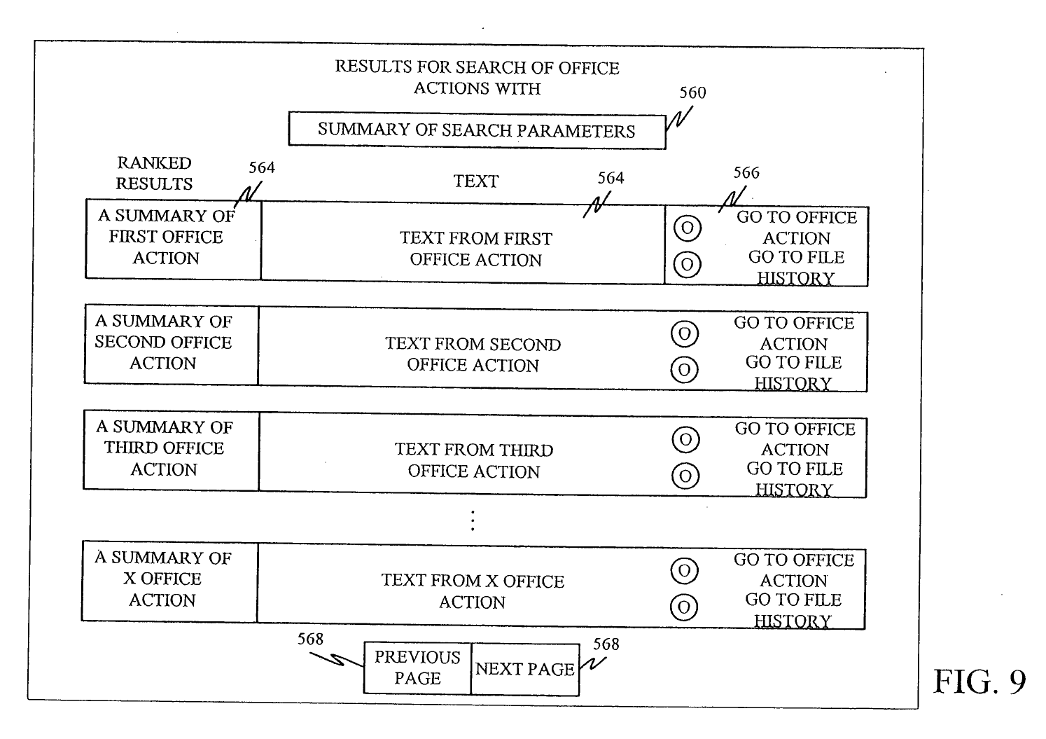

FIGS. 8 and 9 show two different embodiments of user interfaces that can be generated by system 108 based on the data returned by data search system 118, to present results 120 to the user. In FIG. 8, the user interface first includes a summary of the search parameters 550. This summary is illustratively generated in a field 550 and summarizes the various parameters selected at user interface 522, upon which the search was conducted. Below that, in FIG. 8, the results include a left hand ranked results column 552 that list the results, ranked by how closely they correspond to the search parameters. The ranked results are illustratively listed in boxes 554, which each include a summary of the office action and an indication as to whether the office action was successfiilly overcome by the applicant. The ranked list 552 can illustratively be scrolled using scroll buttons 559 or thumb 561. By hovering a cursor over one of the boxes 554, or by selecting the box, the full text of the corresponding office action illustratively appears in field 556. Thus, the user can simply select one of the boxes 554 on the left, and the corresponding full text of the office action corresponding to that box will appear in box 556. The user interface shown in FIG. 8 also illustratively includes a button 558, or some other mechanism, that allows the user to navigate to the file history that contains the selected office action (e.g., a pop-up box opens and shows a dated listing of documents in the file history, which the document associated with the button 558 being highlighted within the list to show context). This may be useful for a variety of reasons. For instance, assume that the user has reviewed the full text of the office action in box 556 and found it of interest. Assume also that the box 554 summarizing the office action contains an indication that this office action was successfully overcome by the Applicant. The user may wish to go to the file history to quickly review the response that was filed by the Applicant in order to overcome this office action. Of course, the user may desire to go to the file history for any of a wide variety of other reasons as well.

FIG. 9 shows another embodiment in which the results 120 are presented through a user interface to user 112. In the embodiment shown in FIG. 9, again the user interface shows a summary of the search parameters in field 560, and then has the ranked results listed, in rank order. However, the format of the presentation of the results is slightly different. Again, the results illustratively include a summary box 562 that summarizes the office action. The results shown in FIG. 9 also include a text box 564 that includes a portion of the text from the office action which contains the parameters that caused it to be present in the ranked list of results (NOTE: it should be noted that it is within the scope of the present invention for no text from the office action to be displayed at all or at least initially—e.g., only parameters and characteristics are shown on the results page—or at least the text is not shown unless requested through user input). Finally, the results include a navigation box 566 that allows a user to go to the full text office action or the file history that contains the office action (e.g., a pop up box opens and shows a dated listing of documents organized chronologically with the specific document associated with box 566 being highlighted to demonstrate context). The user can navigate between next and previous pages of search results using the next and previous page buttons 568.

While two embodiments of search results are shown in FIGS. 8 and 9, any of a wide variety of other embodiments for displaying search results can be used as well, and the present invention is not limited to those shown.

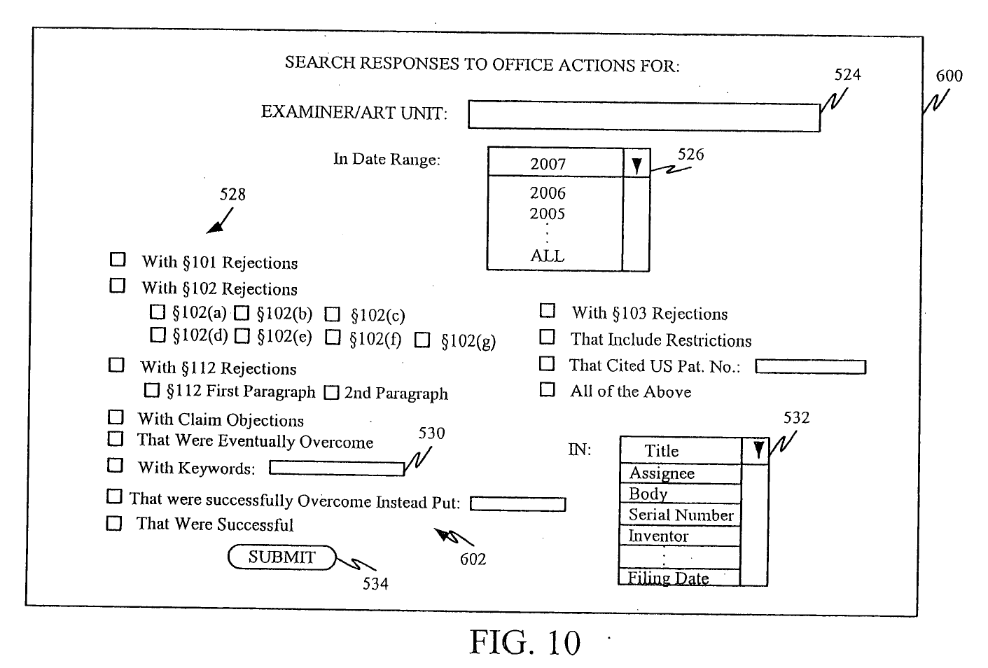

Now assume that in FIG. 4, the user has indicated that the user desires to search responses to office actions for the given Examiner. In that case, a system 108 illustratively again provides a user interface to the user, such as user interface 600 shown in FIG. 10, allowing the user to more distinctly specify the parameters for conducting the search. It can be seen that the parameters include parameters 528 shown in FIG. 7, and additional parameters 602 that indicate that the response was successful. This may be extremely helpful, for example, if a user has a similar type of rejection which was overcome by a response to another office action before the same Examiner. Again, once the parameters are selected, the user simply actuates the submit button 534 and data search system 118 generates the search results, as described above with respect to FIG. 7.

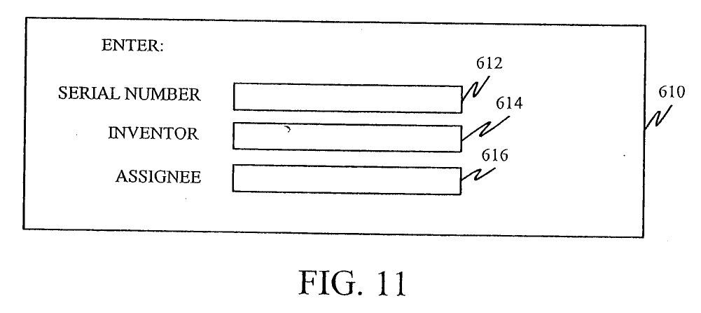

Now assume that in FIG. 2, the user has indicated a desire to search information about a specific serial number, inventor, or assignee. System 108 will illustratively provide a user with a user interface, such as user interface 610 shown in FIG. 11. This allows the user to enter the serial number, inventor, or assignee in text boxes 612, 614, or 616, respectively. If the user selects a serial number, data search system 118 illustratively presents a list of documents contained in the file history for that serial number to the user. The user can then simply actuate hyperlinks to the various documents to view whatever document the user desires. If the user enters a specific inventor name, data search system 118 illustratively presents a list of serial numbers and titles, and other summary information, which have the identified inventor as an inventor on the case.

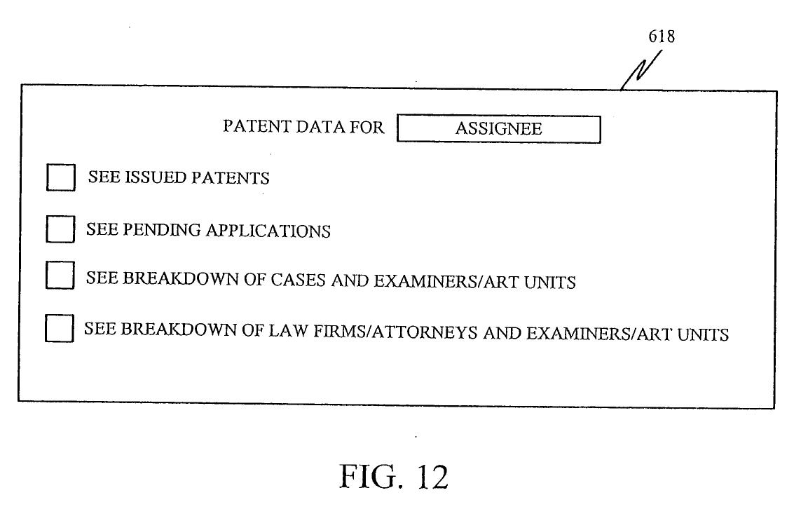

If, however, the user desires to search based on a given assignee, system 108 will illustratively allow the user to more specifically identify the information sought such as by providing a user interface 618 such as that shown in FIG. 12. User interface 618 shown in FIG. 12 allows the user 112 to specify the data sought for a given assignee. This user can simply check the various boxes on user interface 618, such as the issued patents, the pending applications, a breakdown of cases and Examiners in the various art units for the identified assignee, or a breakdown of law firms/attorneys and Examiners or art units for the given assignees.

The first two parameters are fairly straightforward and simply generate a list of issued patents or pending applications with the identified assignee. Assume, however, that the user has chosen a breakdown of cases and Examiners or art units. In that case, data search system 118 will generate queries or execute preformed queries to obtain the necessary information from aggregated Examiner data 106. The data will then be presented back through user interface system 108 as search results 120 in an appropriate search user interface 116, to user 112.

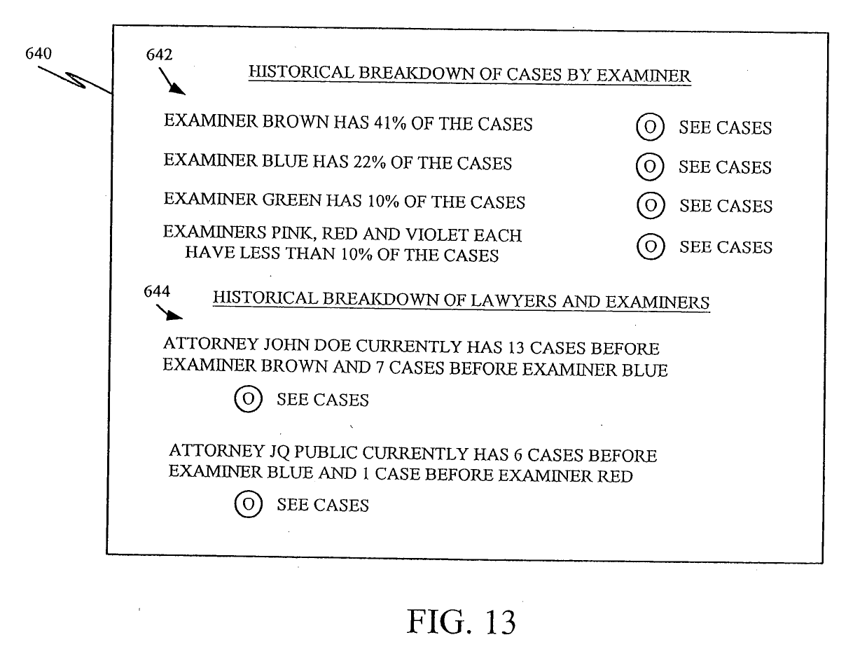

FIG. 13 shows one embodiment of a user interface 640 that can be used to report such results. A user interface 640 includes a top portion which identifies “a historical breakdown of cases by Examiner”. This portion 642 identifies the various Examiners, and the percent of cases for the identified assignee that the Examiner is handling. For instance, user interface 640 shows that Examiner Brown has 41 percent of the cases for this assignee, while Examiner Blue has 22 percent and Examiner Green has 10 percent. User interface 640 also indicates that Examiners Pink, Red and Violet have less than 10 percent of the cases for this assignee. The embodiment of the user interface 640 shown in FIG. 13 also presents radio buttons that can be selected by the user to see a list of hyperlinks to the various cases that each of the Examiners have. Those hyperlinks will illustratively allow the user to pull up the file histories for each of those cases as well.

The bottom portion 644 of user interface 640 identifies a current or historical breakdown of lawyers and Examiners for this assignee. For instance, the breakdown indicates that attorney John Doe currently has 13 cases before Examiner Brown and 7 cases before Examiner Blue. This can be very helpful for a client that desires expeditious prosecution. For instance, by identifying which attorneys have the most cases with a given Examiner, where a client uses a variety of different patent attorneys to obtain its patents, the client can identify which attorneys have the most cases before the various Examiners. It can be very helpful to develop a personal rapport with patent Examiners. Therefore, by aggregating all cases before a given Examiner with one, or a small group of, attorneys, those attorneys may have better success in prosecuting the patents, because they have come to know the Examiner better.

FIG. 13 also shows that attorney JQ Public currently has 6 cases before Examiner Blue and 1 case before Examiner Red. Again, radio buttons are provided so that the user can see the specific cases being handled by those attorneys, before the identified Examiners.

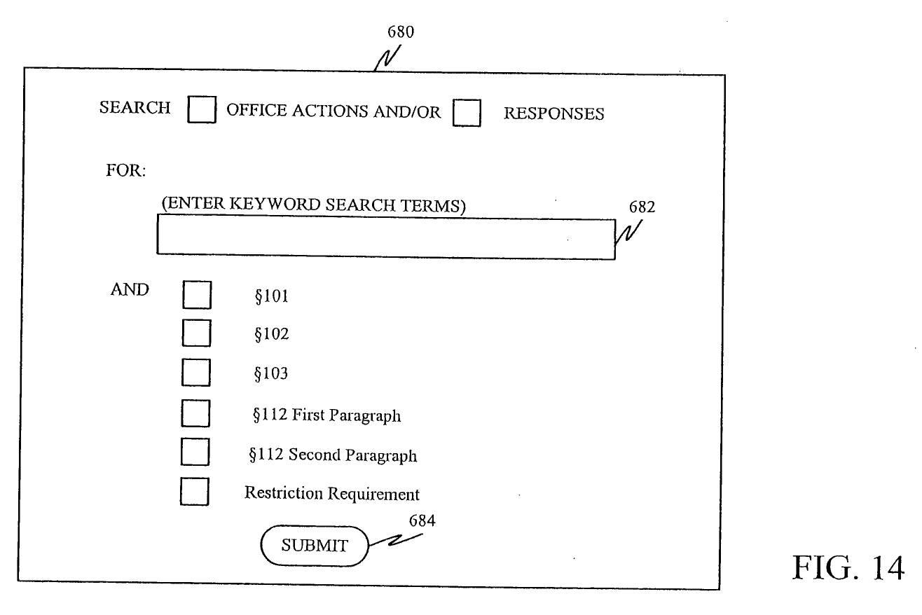

Now assume that, in FIG. 2, the user has made a selection indicating that the user desires to perform keyword searching. In that case, search user interface system 108 illustratively generates a user interface, such as user interface 680 shown in FIG. 14, which allows the user to enter the keywords and various other parameters that the user desires for searching. The embodiment shown in FIG. 14 shows that user interface 680 allows the user to select searching of office actions and/or responses, simply by selecting the appropriate boxes, and then allows the user to enter keywords into field 682. The embodiment shown in FIG. 14 also allows the user to select additional parameters, such as statutory sections addressed by the office actions or responses, such as limiting the office actions or responses to those which were eventually overcome by the applicant, identify those office actions which identify restriction requirements, etc. Once the desired parameters are selected, and the desired keywords are entered into field 682, the user simply needs to actuate the submit button 684. This causes data search system 118 to generate a new query, or execute a preformed query, based on the parameters and keywords identified in user interface 680. Similarly, where PTO interface 126 provides all the necessary search functionality for keyword searching, the user may simply be directed to PTO interface 126 to conduct searching.

It will be appreciated that a wide variety of different user interface configurations can be used in the present system. Those shown are for exemplary purposes only. Appendix F includes a list identifying other types of user interface elements, and the items which they can be illustratively used for. Although this list is not even exhaustive, of course,

It will also be noted that the results can be used in a wide variety of different ways. Similarly, the various searches that can be conducted using the present system need not be limited to those shown and discussed here, but the searches can be substantially any searches desired in aggregated Examiner data 106. Those listed are exemplary only.

Although the present invention has been described with reference to preferred embodiments, workers skilled in the art will recognize that changes may be made in form and detail without departing from the spirit and scope of the invention.

What is claimed is:

1. A method of doing business, comprising:
maintaining a collection of information related to writings created by patent examiners during the processing of patent applications;
providing, based at least in part on the collection of information, data that is specific to a particular patent examiner and is indicative of decisions made by the particular patent examiner during the prosecution of more than one patent application; and
receiving compensation in return for said proving information.

2. The method of claim 1, wherein providing comprises providing an indication of the particular examiner's decisions in relation to an appeal process.

3. The method of claim 1, wherein providing comprising providing data related to an appeal process.

4. The method of claim 1, wherein providing an indication of how often an appeal decision is issued after the filing of a notice of appeal.

5. The method of claim 1, wherein providing comprises providing an indication of how often an appeal decision is not issued after the filing of a notice of appeal.

6. The method of claim 1, wherein providing comprises providing an indication of how often a notice of allowance is issued after a notice of appeal is filed.

7. The method of claim 1, wherein providing comprises providing a report.

8. The method of claim 1, wherein providing comprises providing a consultation service.

9. The method of claim 1, wherein providing comprises providing an indication of how frequently the particular examiner asserts a particular rejection basis.

10. The method of claim 1, wherein providing comprises providing an indication of how frequently the particular examiner asserts a particular combination of rejections.

11. The method of claim 1, wherein providing comprises providing an indication of how frequently the particular examiner asserts a restriction requirement.

12. The method of claim 1, wherein providing comprises providing an internet-based information service.

13. The method of claim 1, wherein providing comprises providing a subscription-based information service.

14. The method of claim 1, wherein providing comprises providing a computer-implemented search interface that enables a user to select the particular patent examiner.

15. A computer-implemented information service, comprising:
a selection interface that enables a user to select a particular patent examiner or set of patent examiners;
a collection of information related to file history documents created by the selected patent examiner or examiners during the prosecution of patent applications;
a payment interface that enables the user to pay for data derived from the collection of information and indicative of decisions made by the particular patent examiner or examiners made during prosecution of the patent applications.

16. The system of claim 15, wherein the data is delivered to the user in the form of a report.

17. The system of claim 15, wherein the data is delivered to the user in the form of a consultation service.

18. The system of claim 15, wherein the data is related to an appeals process.

19. The system of claim 15, wherein the data for which the user pays includes prosecution-related statistics.

20. A computer-implemented user interface configured to facilitate payment or billing for statistical data derived from a collection of information related to prosecution history documents created by one or more patent examiners during the prosecution of patent applications.
